(19) United States
(12) Patent Application Publication
(10) Pub. No.: US 2007/0279295 A1
(43) Pub. Date: Dec. 6, 2007

(54) ANTENNA DEVICE AND SHELF TYPE READER SYSTEM

(75) Inventors: Eiichirou NAKAZONO, FUKUOKA (JP); Futoshi DEGUCHI, FUKUOKA (JP); Masahiko TANAKA, FUKUOKA (JP); Kenji ICHIKAWA, SAGA (JP); Takeshi GOTO, FUKUOKA (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/755,969

(22) Filed: May 31, 2007

(30) Foreign Application Priority Data
Jun. 2, 2006 (JP) 2006-154280

(51) Int. Cl. H01Q 9/04; G08B 13/14

(52) U.S. Cl. 343/700 MS; 340/572.7

(57) ABSTRACT

An antenna device is provided for which the thickness can be reduced, warping can be prevented, and manufacturing can be easily performed. According to the present invention, the antenna device includes: a support member, formed like a long hollow plate by extruding a resin; and an antenna unit, wherein a plurality of antenna elements, which are thin metal plates formed substantially in a U shape and which include a first coupling portion extended from one end in one direction and a second coupling portion extended from the other end in the opposite direction, grip the external sides of the support member in the longitudinal direction. The first coupling portion of a specific antenna element is connected to the second coupling portion of the adjacent antenna element, and the second coupling portion of the specific antenna element is connected to the first coupling portion of the adjacent antenna element. Since the antenna elements are connected in this manner, the antenna unit is formed like a coil.

### BACKGROUND

The present invention relates to an antenna device provided for a reader system used for RFID wireless IC tags, and a shelf type reader system that incorporates the antenna device.

An RF tag is operated by electromagnetic induction produced power supplied via an antenna device that is provided for an RFID reader system, and a load change of the RF tag is received by the antenna device of the RFID reader system. Information thus collected by the antenna device is then used by the RFID reader system. As an employment example, when RF tag bearing goods are stored on shelves within which antenna devices for an RFID reader system are arranged, relevant information can be obtained concerning the disposition of the RF tags and the goods to which attached. However, to function properly, the magnetic field of each antenna device mounted within each shelf must be uniformly distributed. A conventional antenna device that is mounted within a shelf and is used for an RFID reader system is described in patent document 1 (JP-A-7-182357).

The antenna device described in patent document 1 serves as a tag search device, and a plurality of coils are arranged at predetermined locations along the main body of the search device.

Furthermore, another conventional antenna device 200 is shown in FIGS. 10A and 10B. A plate-like ferrite member case 202, wherein a ferrite member (not shown) is arranged, is mounted on an elongated printed wiring board 201, and antenna elements 203, which are metal plates bent substantially into a U shape, are arranged in a column across the ferrite member case 202. A wiring pattern 204, which is inclined longitudinally, is provided for the printed wiring board 201, so that on one side the end of an antenna element 203 is connected to the end of an adjacent antenna element 203 on the other side. When the antenna elements 203 are inserted into mounting holes and are soldered to the wiring pattern 204, while the distal ends of the antenna elements 203 are bent inward, the antenna elements 203 are connected like coils. According to the conventional antenna device 200 shown in FIGS. 10A and 10B, wherein the antenna elements 203 are arranged in a column on the elongated printed wiring board 201 and are soldered to the wiring pattern, stress produced by pulling acts on the reverse surface of the printed wiring board 201. However, since the antenna elements 203 are not directly coupled, the printed wiring board 201 would be warped.

Further, the thickness of the conventional antenna device 200 would be increased because the thickness is the sum of that of the antenna elements 203, which are bent, and that of the soldered portion. Since there is a limitation imposed by the thickness of a shelf board within which the conventional antenna device 200 is to be mounted, the antenna device 200 can not be accommodated when the soldered portion becomes too thick. In addition, when the antenna elements 203, which are metal plates, are to be soldered to the wiring pattern 204 with their distal ends bent inward, the soldering of a relatively large area is required, and the process becomes troublesome.

### SUMMARY

Therefore, one objective of the present invention is to provide an antenna device, having a compact body, that can be easily manufactured, and a shelf type reader system that includes this antenna device.

According to the present invention, a shelf type reader system comprises:
a plurality of shelves, which are arranged at intervals and are substantially parallel to each other;
antenna devices provided for the shelves;
a reader main body, for reading information obtained from IC tags, adhered to goods stored on a shelf, from which the antenna device receives signals;
a support plate; and
an antenna unit, which is provided to cover external surfaces of the support plate and includes a plurality of antenna elements, formed of metal plates, arranged apart from each other,
wherein cross sections of the antenna elements have a U-like shape, so that opposite ends the antenna element are adjacent, and a first coupling portion that is extended, from one end of each of the antenna elements, substantially upward and in the longitudinal direction of the support plate, while a second coupling portion is extended, from the other end of each antenna element, substantially downward in the longitudinal direction of the support plate, and
wherein the first coupling portion of each of the antenna elements is coupled to the second coupling portion of an adjacent antenna element, and the second coupling portion is coupled to the first coupling portion of the adjacent antenna element, so that the entire antenna unit is formed in a coil like shape.

### BRIEF DESCRIPTION OF THE DRAWINGS

FIGS. 1A and 1B are perspective views of the general appearance of a reader system according to one embodiment of the present invention;

FIG. 2 is a perspective view of an antenna device used for the reader system of the embodiment of the invention;

FIG. 3 is a perspective view of the main body of the antenna device according to the embodiment of the invention;

FIG. 4 is an exploded perspective view of the support member of the antenna device according to the embodiment of the invention;

FIG. 5 is an enlarged perspective view of the essential portion of the coil member of the antenna device according to the embodiment of the invention;

FIG. 6 is a perspective view of the antenna unit of the antenna device of the embodiment of the present invention;

FIG. 7 is a perspective view of an antenna element provided for the antenna device according to the embodiment of the invention;

FIG. 8 is an exploded perspective view of a fitting portion for mounting the antenna main body of the antenna device according to the embodiment of the invention;

FIG. 9 is a diagram showing the printed wiring board of the antenna device according to the embodiment of the invention; and

FIGS. 10A and 10B are diagrams showing a conventional antenna device.

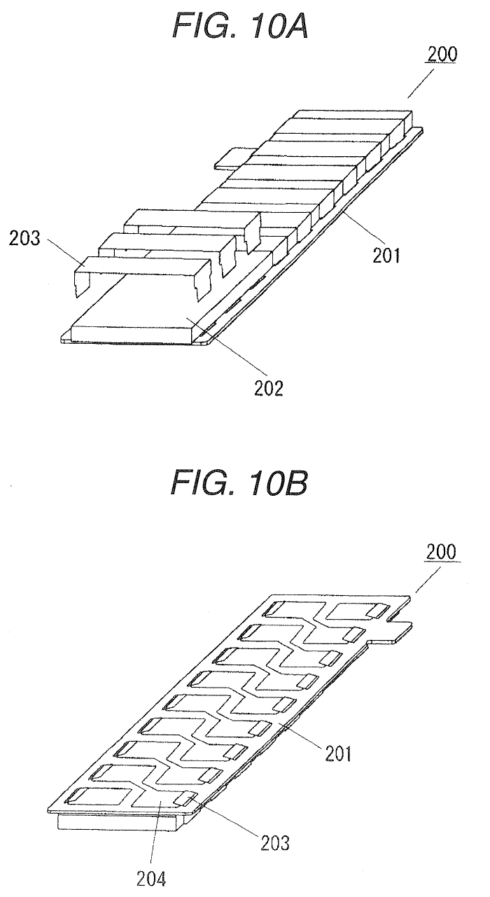

### DETAILED DESCRIPTION

An antenna device according to the preferred embodiment of the present invention will now be described while referring to the accompanying drawings.

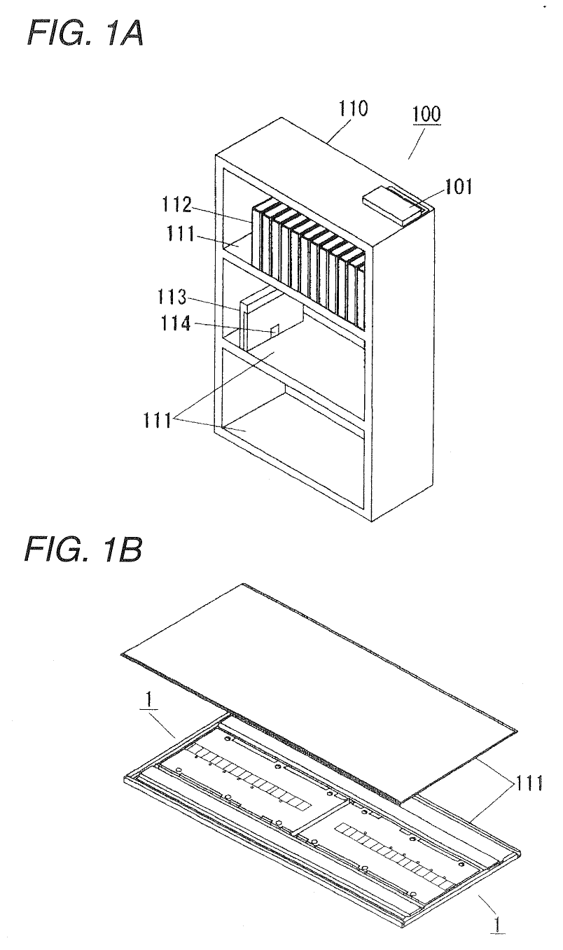

First, while referring to FIG. 1, an explanation will be given for the installation state of a shelf type reader system, used for an RFID wireless IC tag, that employs an antenna device according to the embodiment.

FIGS. 1A and 1B are diagrams showing the installation state of an RFID reader system, i.e., FIG. 1A is a diagram showing a book cabinet wherein the RFID reader system is installed, and FIG. 1B is a diagram showing the state wherein the antenna device for this embodiment is mounted within a shelf of the book cabinet.

As shown in FIGS. 1A and 1B, the RFID reader system 100 includes: a main body (reader body) 101, positioned on the top of the cabinet 110; and antenna devices 1, two of which are mounted within each shelf board 111 of the cabinet 110. According to the RFID reader system 100, electromagnetic induction produced power is supplied by the antenna devices 1, at 13.56 MHz, to RF tags 114 that are adhered to books 112 and a notebook computer 113 that are stored on the shelf boards 111 of the cabinet 110, and while the RF tags 114 are operating, the antenna devices 1 receive load changes, from the RF tags 114, that they output to the main body 101. In this manner, non-contact communication is enabled.

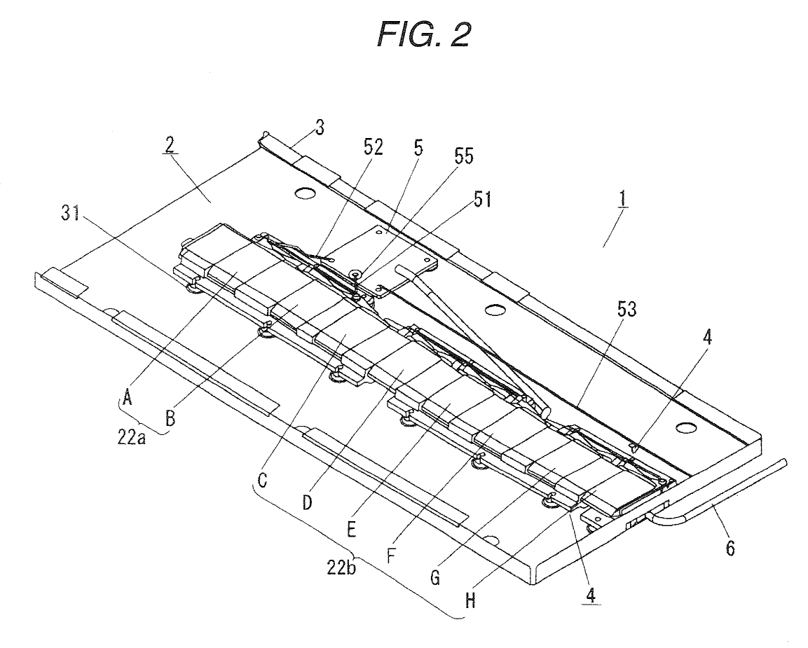

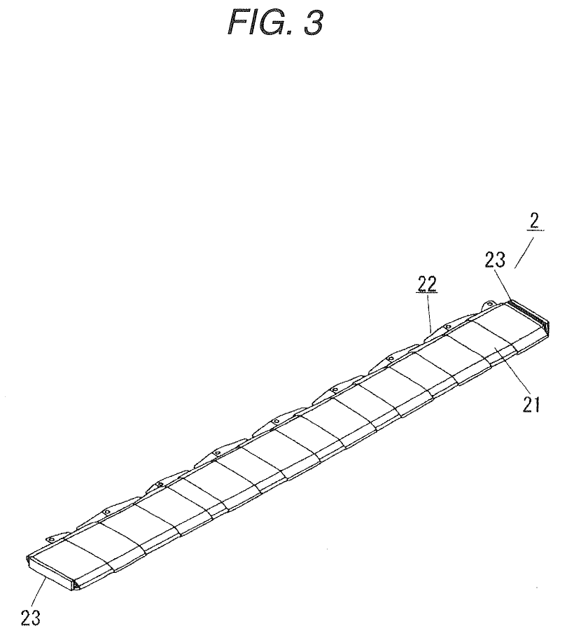

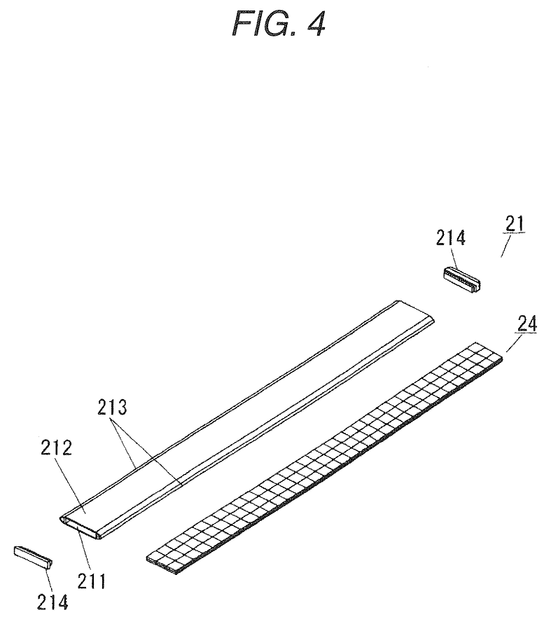

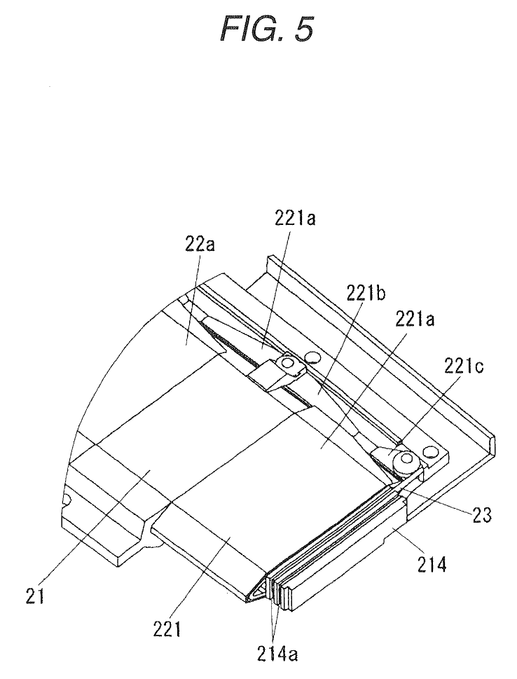

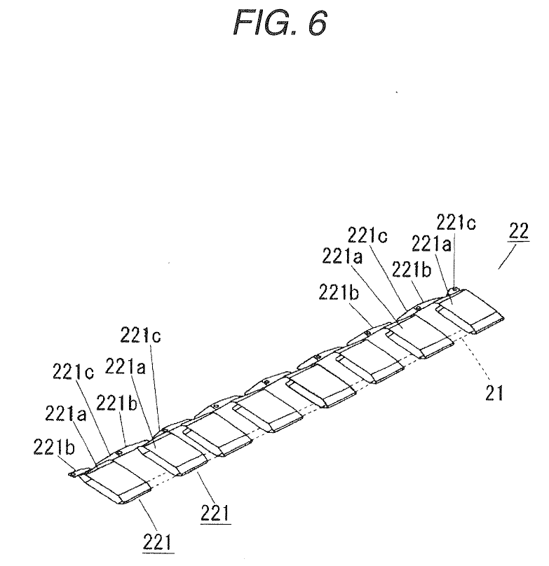

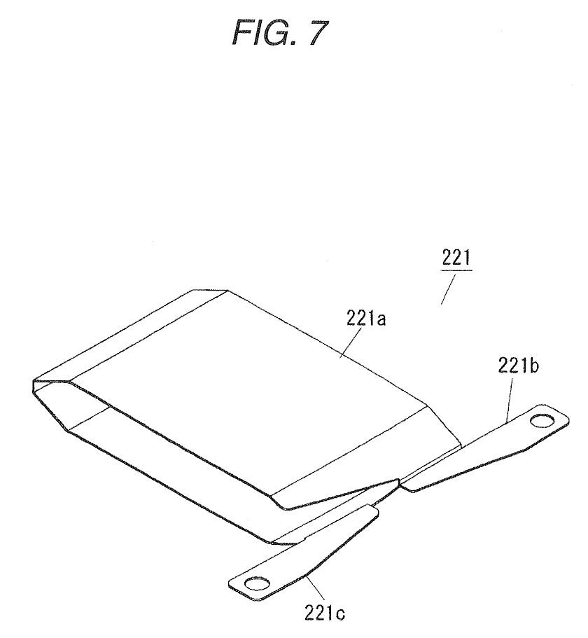

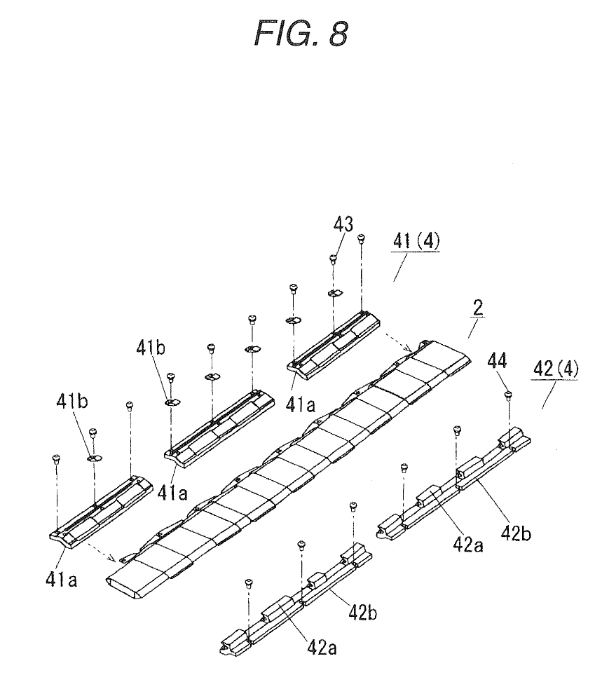

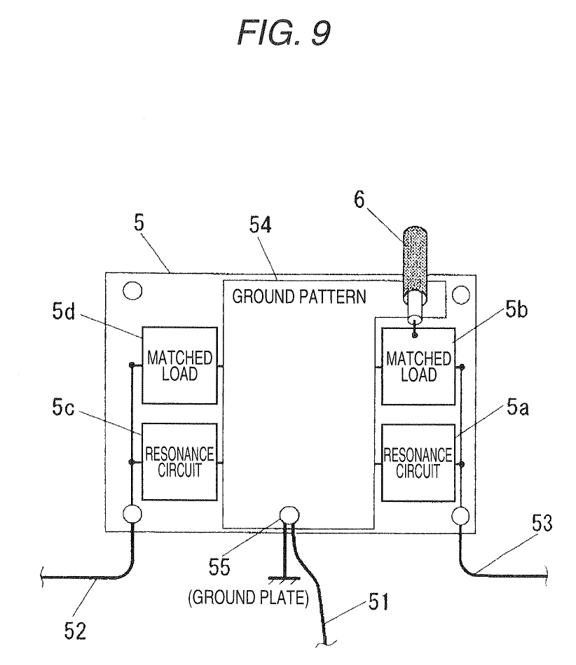

The structure of the antenna device 1 will be described while referring to FIGS. 2 to 8. FIG. 2 is a perspective view of the state wherein the antenna device of this embodiment is mounted on a ground plate. FIG. 3 is a perspective view of an antenna main body. FIG. 4 is an exploded perspective view of a support member. FIG. 5 is an enlarged diagram showing the essential part of a coil member. FIG. 6 is a perspective view of an antenna unit. FIG. 7 is a perspective view of an antenna element. FIG. 8 is a perspective view of a fitting portion for attaching the antenna main body. And FIG. 9 is a diagram showing a printed wiring board.

As shown in FIG. 2, the antenna device 1 includes an antenna main body 2, a ground plate 3, fitting portions 4, a printed wiring board 5 and a coaxial cable 6. To store the antenna device 1 within the shelf board 111 (see FIG. 1B), the antenna main body 2 is mounted on the ground plate 3 using the fitting portion 4, and the printed wiring board 5 is attached to the ground plate 3.

As shown in FIG. 3, the antenna main body 2 includes: a support member 21 shaped a long plate; an antenna unit 22; and coil members 23 located at the distal ends of the support member 21.

As shown in FIG. 4, the support member 21 is provided by assembling a storage member 212, which has a rectangular cross section and has a hollow portion 211 for storing a ferrite member 24, and edge members 213, which have triangular cross section and are provided along the sides of the storage member 212. The ferrite member 24 is formed of arrays of ferrite blocks, and is arranged in the hollow portion 211 of the storage member 212. In this embodiment, ferrite is employed; however, another magnetic material, such as cobalt or nickel, may be employed instead.

The support member 21 can be obtained by the extrusion of a resin. When the manufacture of the support member 21 using extrusion is enabled, an expensive molded die having the shape of the entire support member 21 is not required; simply a molded die having the vertical cross sectional shape of the support member 21 can be used. Further, when the support member 21 is formed by extrusion, the two ends of the support member 21 are openings into the interior of the hollow portion 211. Since the hollow portion 211 is formed in the support member 21 obtained by extrusion, warping of the support member 21 can be avoided, even though the support member 21 is shaped like a long plate. In this embodiment, lids 214 are provided that are fitted into the openings in the hollow portion 211 to maintain the closed state. And when the hollow portion 211 has been closed with the lids 214, not only is the ferrite portion 24 prevented from coming out through the openings in the hollow portion 211, but also the lids 214 inhibit deformation of the openings of the hollow portion 211. Therefore, the mechanical strength of the support member 21 is increased. Furthermore, since the hollow portion 211 is fully filled with the ferrite portion 24 and there is no intervening gap, the ferrite portion 24 can be stably positioned within the storage member 212. In this embodiment, the support member 21 that is employed is produced through the extrusion of a resin; however, transfer molding may be used to produce a support member formed like a box, so long as the manufacturing cost is not excessive and is still within an acceptable range.

As shown in FIG. 5, a groove 214a, along and within which a coil member 23 is to be wound, is spirally formed in each of the lids 214 used to close the openings of the support member 21. Since the grooves 214a are formed in the lids 214, for the winding of the coil members 23, the coil members 23 can be securely fixed at respective ends of the support member 21. In this embodiment, lead lines are wound twice around the lids 214 to provide the coil members 23.

As shown in FIG. 6, a plurality of antenna elements 221, composed of thin metal plates, are coupled, one to the other, to provide the antenna unit 22, which is then attached to the support member 21.

As shown in FIG. 7, each of the antenna elements 221 includes: an element plate 221a, which is a thin copper plate having a substantially U shape; a first coupling portion 221b, which is extended from one end of the element plate 221a in one direction (substantially in the axial direction (the longitudinal direction) of the support member 21); and a second coupling portion 221c, which is extended from the other end of the element plate 221a in the opposite direction (substantially in the axial direction (longitudinal direction) of the support member 21). In this embodiment, a thin copper plate is employed for the antenna element 221; however, other conductive metals can be employed. This antenna element 221 is connected, by a rivet, to the second coupling portion 221c of an antenna element 221 adjacent to the first coupling portion 221b, and is connected to the second coupling portion 221c of an antenna element 221 adjacent to the second coupling portion 221b. As a result, the antenna unit 22 is formed like a coil.

As shown in FIG. 2, for the antenna unit 22 of this embodiment, eight antenna elements 221 A to H altogether are engaged to grip the external walls of the support member 21 in the longitudinal direction. The eight antenna elements 221 are separated into two antenna elements A and B, which serve as a first antenna unit 22a, and six antenna elements A to H, which serve as a second antenna unit 22b.

That is, two types of antenna devices, the first antenna unit 22a and the second antenna unit 22b, are provided by the employment, in common, of the support member 21. When the eight antenna elements 221 are connected while sorted into two sections in this manner, the first antenna unit 22a and the second antenna section 22b, which have different functions, can be obtained. Thus, the antenna device 1, which provides a large band, can be easily provided. In this embodiment, the first antenna unit 22a is employed as a passive antenna, and the second antenna unit 22b is employed as an active antenna.

The first antenna unit 22a and the second antenna unit 22b are wound in reverse directions, when viewed from a common grounding portion 55, so that a high frequency current flows, in the same direction, through the first and the second antenna units 22a and 22b. Further, the mounting intervals for the antenna elements of the first antenna unit 22a (the distance between the antenna elements in the longitudinal direction of the support member 21) differ from the mounting intervals for the antenna elements of the second antenna unit 22b, in order to distribute an appropriate distance for the coupling the antenna elements.

As shown in FIG. 5, the coil members 23 are coils, formed of lead lines, that are connected to the second coupling portions 221c of the antenna elements 221 at the distal ends of the antenna unit 22. Since the coil members 23 are provided for the antenna element 221 at the distal ends, a loop line can be obtained that generates a null point only at the coil members 23, and that reduces the possibility of the occurrence of a null point in the other antenna elements 221.

As shown in FIG. 2, the ground plate 3 is a metallic, substantially box shaped base plate in which a upward facing opening is formed. The ground plate 3 is electrically connected to the first antenna unit 22a and the second antenna unit 22b, using the common ground portion 55, and thus, a antenna device 1 is provided as a grounded antenna device. Since the antenna device 1 is grounded, the affect produced by metal in areas surrounding the shelf boards 111 (see FIG. 1) that are installed can be reduced. Therefore, the electric condition required for the installation of the antenna device 1 can be relaxed. Convex portions 31, in the tops of which screw holes are formed, are located at predetermined positions on the ground plate 3, and are used to fasten the antenna main body 2 to the fitting portion 4.

As shown in FIGS. 2 and 8, the fitting portion 4 includes a first fitting portion 41, for securing one side of the antenna main body 2 to the ground plate 3, and a second fitting portion 42, for securing the other side.

The first fitting portion 41 is used to secure the portion whereat the antenna elements 221 are coupled together, and includes: three bases 41a having inclined faces on which the side walls of the antenna elements 221 are to be mounted; and fixing portions 4 lb, for securing the side walls of the antenna elements 221 from above.

The second fitting portion 41 includes: engagement portions 42a, having a V shape in cross section, that engage the edge member 213 of the support member 21 located between an antenna element 221 and an adjacent antenna element 221; and support portions 42b that are so arranged that the engagement portions 42a are separated, for sandwiching the antenna elements 221.

When the antenna main body 2 is to be attached to the ground plate 3, first, the screw holes in the bases 41a are aligned with the convex portions 31 of the ground plate 3, and the side wall of the antenna main body 2 is aligned with the inclined faces of the bases 41a. Then, the second fitting portion 42 is moved in, from the side of the antenna main body 2, and the engagement portions 42a are fitted on the support member 21. Then, while the screw holes of the fixing portions 41b are aligned with the screw holes of the bases 41a, screws 43 are inserted into the screw holes and fastened. Finally, the second fitting portion 42 is fastened down with screws 44, and as a result, the antenna main body 2 can be fixed to the ground plate 3. Since the second fitting portion 42 not only secures the support member 21 to the ground plate 3, but also is fitted on the support member 21 for sandwiching the antenna elements 221, the antenna elements 221 are inhibited from moving in the longitudinal direction of the support member 21. Therefore, when the support member 21 is mounted on the ground plate 3, the antenna elements 221 can be stably positioned.

As shown in FIGS. 2 and 9, the printed wiring board 5 is a circuit board on which is mounted an antenna circuit connected to the antenna unit 22. The printed wiring board 5 is fastened to the ground plate 3 with screws, and is connected to the antenna unit 22 using a first lead line 51, a second lead line 52 and a third lead line 53. The first lead line 51 is extended from a node of the second coupling portion 221c, of the antenna element B, at the base end of the first antenna unit 22a, and the first coupling portion 221b of the antenna element C, at the base end of the second antenna unit 22b, to the common grounding portion 55 of a ground pattern 54 that is formed on the printed wiring board 5 and that is electrically connected to the ground plate 3. The second lead line 52 is extended from the first coupling portion 221b of the antenna element A, at the distal end of the first antenna unit 22a. The third lead line 52 is extended from the coil member 23, provided for the antenna element H, at the distal end of the second antenna unit 22b. Further, as an antenna circuit, a resonance circuit 5a and a matched load 5b, for the first antenna unit 22a, and a resonance circuit 5c and a matched load 5d, for the second antenna unit 22b, are mounted on the printed wiring board 5, and these components are connected to the ground pattern 54. The matched load 5b is further connected to the main body 101 (see FIG. 1A) by the coaxial cable 6. When this printed wiring board 5 is arranged beside the antenna unit 22, the entire height of the antenna device 1 can be reduced.

As described above, according to the antenna device 1 of this embodiment, the antenna elements 221, made of thin metal plates that are substantially U shaped, are fitted onto the support member 21 like a long plate, so as to grip the external walls of the support member 21. Thus, the thickness of the antenna device 1 can be almost equal to the thickness of the support member 21, and the overall thickness of the antenna device 1 can be reduced. Furthermore, the first coupling portions 221b and the second coupling portions 221c are employed to connect the antenna elements 221, and soldering to the printed wiring board is not required. Therefore, warping is prevented, and since a troublesome operation can be eliminated, the antenna device can be easily manufactured.

Further, since the antenna device 1 of this embodiment does not require soldering, no portions on the reverse face of the antenna main body 2 project downward from the ground plate 3. Therefore, for the antenna device 1, a stable function can be obtained.

The antenna device 1 of this embodiment is appropriate for an RFID reader system, and the present invention can also be applied for an antenna device that is shaped like a coil.

Many modifications and variations of the present invention are possible in the light of the above techniques. It is therefore to be understood that within the scope of the invention the invention may be practiced otherwise than as specifically described.

This application is based upon and claims the benefit of priority of Japanese Patent Application No. 2006-154280 filed on Jun. 2, 2006, the contents of which are incorporated herein by reference in its entirety.

What is claimed is:

1. An antenna device comprising:
a support plate; and
an antenna unit, which is provided to cover external surfaces of the support plate, and includes a plurality of antenna elements, formed of metal plates, arranged apart from each other,
wherein each of the antenna elements has an element plate portion having a U-like shape cross section, a first coupling portion extended from one end of the element plate portion substantially upward in the longitudinal direction of the support plate, and a second coupling portion extended from the other end of the element plate portion substantially downward in the longitudinal direction of the support plate, and
wherein the first coupling portion of each of the antenna elements is coupled to the second coupling portion of an adjacent antenna element, and the second coupling portion is coupled to the first coupling portion of the adjacent antenna element, so that the entire antenna unit is formed in a coil like shape.

2. An antenna device according to claim 1, wherein the antenna unit includes a first antenna part having a predetermined number of adjacently arranged antenna elements, and a second antenna part having a predetermined number of adjacently arranged antenna elements; and
wherein individual coil portions of the first and the second antenna parts are wound in different directions.

3. An antenna device according to claim 1, wherein the antenna unit includes a first antenna part having a predetermined number of adjacently arranged antenna elements, and a second antenna par having a predetermined number of adjacently arranged antenna elements; and
wherein a distance between the antenna elements of the first antenna part differs from a distance between the antenna elements of the second antenna part.

4. An antenna device according to claim 1, wherein the antenna unit includes a first antenna part having a predetermined number of adjacently arranged antenna elements, and a second antenna part having a predetermined number of adjacently arranged antenna elements; and
wherein electric power is supplied only to the first antenna part, and the second antenna part serves as an antenna driven by power produced by electromagnetic induction relative to the first antenna part.

5. An antenna device according to claim 1, wherein a coil member is provided at an end of the topmost antenna element of the antenna unit, and is electrically connected to the topmost antenna element.

6. An antenna device according to claim 1, wherein a hollow portion is formed in the support member, and a magnetic material is stored in the hollow portion.

7. An antenna device according to claim 6, wherein lids are provided at one or both ends of the support member so as to be fitted into an opening in the hollow portion, and the lids are formed with grooves within which the coil members are to be wound.

8. An antenna device according to claim 1, further comprising:
a casing portion, made of metal, that covers the antenna device,
wherein a fitting portion is arranged for the support member to secure the plurality of antenna elements relative to the support member, and to fix the support member to the casing portion.

9. An antenna device according to claim 8, wherein a circuit board, on which is mounted an antenna circuit to be coupled to the antenna unit, is located adjacent to the antenna unit in the casing portion.

10. A shelf type reader system comprising:
a plurality of shelves, which are arranged apart from each other and are substantially parallel to each other;
antenna devices provided for the shelves;
a reader main body, for reading information obtained from IC tags, attached to goods put on a shelf, from which the antenna device receives signals;
a support plate; and
an antenna unit, which is provided to cover external surfaces of the support plate and includes a plurality of antenna elements, formed of metal plates, arranged apart from each other, at intervals,
wherein each of the antenna elements has an element plate portion having a U-like shape cross section, a first coupling portion extended from one end of the element plate portion substantially upward in the longitudinal direction of the support plate, and a second coupling portion extended from the other end of the element plate portion substantially downward in the longitudinal direction of the support plate, and
wherein the first coupling portion of each of the antenna elements is coupled to the second coupling portion of an adjacent antenna element, and the second coupling portion is coupled to the first coupling portion of the adjacent antenna element, so that the entire antenna unit is formed in a coil-like shape.

11. A shelf type reader system according to claim 10, wherein the antenna unit includes: an antenna circuit, connected to the reader main body, for processing information obtained by the antenna unit.
